(19) United States
(12) Patent Application Publication
(10) Pub. No.: US 2019/0180235 A1
(43) Pub. Date: Jun. 13, 2019

(54) TRANSPORTATION SYSTEMS AND METHODS

(71) Applicant: Flexport, Inc., San Francisco, CA (US)

(72) Inventor: Ryan PETERSEN, San Francisco, CA (US)

(21) Appl. No.: 16/300,015

(22) PCT Filed: May 12, 2017
(86) PCT No.: PCT/US2017/032557

§ 371 Date: Nov. 8, 2018

Related U.S. Application Data
(60) Provisional application No. 62/335,315, filed on May 12, 2016.
(60) Provisional application No. 62/359,190, filed on Jul. 6, 2016.
(60) Provisional application No. 62/417,222, filed on Nov. 3, 2016.
(60) Provisional application No. 62/419,936, filed on Nov. 9, 2016.
(60) Provisional application No. 62/428,459, filed on Nov. 30, 2016.

(51) Int. Cl. G06Q 10/08; G01C 21/34

(52) U.S. Cl. CPC G06Q 10/08345; G01C 21/3453

(57) ABSTRACT

This disclosure pertains to systems and methods for moving things from a Start Location to an End Location, which provide users with reduced costs, improved logistics, flexibility, a visualized supply chain, and powerful analytics. In some embodiments, the disclosed systems and methods include a user interface which accepts input from a user, then generates and presents a concrete collection of shipping options meeting user-defined route constraints.

### CROSS REFERENCE TO RELATED APPLICATIONS

This application claims priority under 35 U.S.C. 119 to U.S. Provisional Application Nos.: 62/428,459 filed Nov. 30, 2016; 62/419,936 filed Nov. 9, 2016; 62/417,222 filed Nov. 3, 2016; 62/359,190 filed Jul. 6, 2016; and 62/335,315 filed May 12, 2016, all of which are hereby incorporated by reference in their entirety.

### TECHNICAL FIELD

This disclosure pertains to systems and methods for transporting physical things from one location to another.

### BACKGROUND

With the rapid development of e-commerce and technology, global commerce has grown substantially. Unfortunately, the shipping, transportation, and freight forwarding industries have not evolved to meet the needs arising from this growth.

Generally speaking, the complexity of shipping a thing increases as the geographic distance increases—especially when the shipping requires crossing international borders.

International shipping and transportation present a complicated logistical problem, requiring coordinating a variety of vendors, partners, transportation modes, customs issues, routing choices, and cost concerns. Often price discrimination makes international shipping untenable for businesses.

U.S. Pat. No. 8,732,032 (the '032 patent) discloses a “multiple-platform estimating and automatic quoting for network-based parts resale with transferable reports.” This disclosure pertains to a part location system utilizing computer-based techniques for bringing together repair facilities and suppliers to increase the efficiency of locating recycled, used or aftermarket parts using a computer network. The disclosed part location system receives an estimate from a first user over a communication network. The part location system then parses the estimate to extract information that identifies a list of parts needed by the first user and automatically generates a request for quote (RFQ) using the information extracted from the estimate. The part location system then sends the RFQ to suppliers via the communication network. Subsequently, the part location system receives quotations from at least one of the suppliers via the communication network in response to the RFQ and presents the quotations received in response to the RFQ to a repair facility via the communication network. However, the '032 patent does not provide a routing engine. Furthermore, the '032 patent only pertains to individual parts without regard to comprehensively coordinating the other parts needed.

Canadian Patent No. 2,370,084 (the CA '084 patent) discloses a “system and method for providing a price quotation for a transportation service providing route selection capability,” which computes the price of a railway transportation service for shipping goods. In the disclosed system, a computer delivers first information to a user prompting the user to enter information about a rail transportation service including an origin and a destination for the shipment of goods. In response to the origin and the destination information, the computer is caused to deliver a series of routes between the origin of the shipment of goods and the destination of the shipment of goods. The user is prompted to select at least one route from the series of routes. A price for the rail transportation service for shipment of goods is then computed at least in part on the basis of the at least one route selected by the user and is provided to the user as a quote for the rail transportation service. However, the CA '084 patent pertains only to rail transportation and thereby lacks the ability to coordinated multiple transportation modes.

U.S. patent application Ser. No. 12/073,663 (US Publication No. 2008-0201274 A1, 2008-0201274 A1, the '663 application) discloses a “system and method for providing a price quotation for a transportation service.” The disclosed method and system apply to computing the price for the transportation of goods on a route where the route has a first segment and a second segment adjacent the first segment. The goods are transported on the first segment by a non-rail mode of transportation and thereafter by rail. A computer is caused to deliver information to a user prompting the user to enter at the computer information conveying one or more characteristics of the first segment. The computer is also caused to deliver information to the user prompting the user to enter at the computer information conveying one or more characteristics of the second segment. A price for the transportation of the goods on the route is then computed at least in part on the basis of the characteristics of the first segment entered by the user and the characteristics of the second segment entered by the user. However, the '663 application provides only for coordinating two segments and requires that one of the segments is rail. Despite the technology disclosed in the '663 application, there still exists a need for systems and methods capable of comparing and using any number of connected segments, with or without rail as one of the modes of transportation.

Although both computers and freight forwarding services have existed for years, the industry has failed to synthesize systems and methods, which compile and evaluate comprehensive sets of options for moving things from a start location to an end location—especially via routes which require multiple transportation modes, crossing international borders or geographic boundaries, such as oceans or other large bodies of water.

There exists a need for managing global freight shipments through systems and methods capable of moving mass from one location to another, thereby transporting things from a specified start location to an end location.

There also exists a need for systems and methods which provide multiple competitive quotes on each shipment through an online dashboard providing a visual representation of shipments in real-time, along with electronic notifications regarding those shipments.

There exists a need for systems and methods for transporting things, which combine an exhaustive route search with a pricing engine.

### BRIEF DESCRIPTION OF DRAWINGS

FIG. 1 illustrates a non-limiting example of how the methods and systems receive information and proceed to display the results.

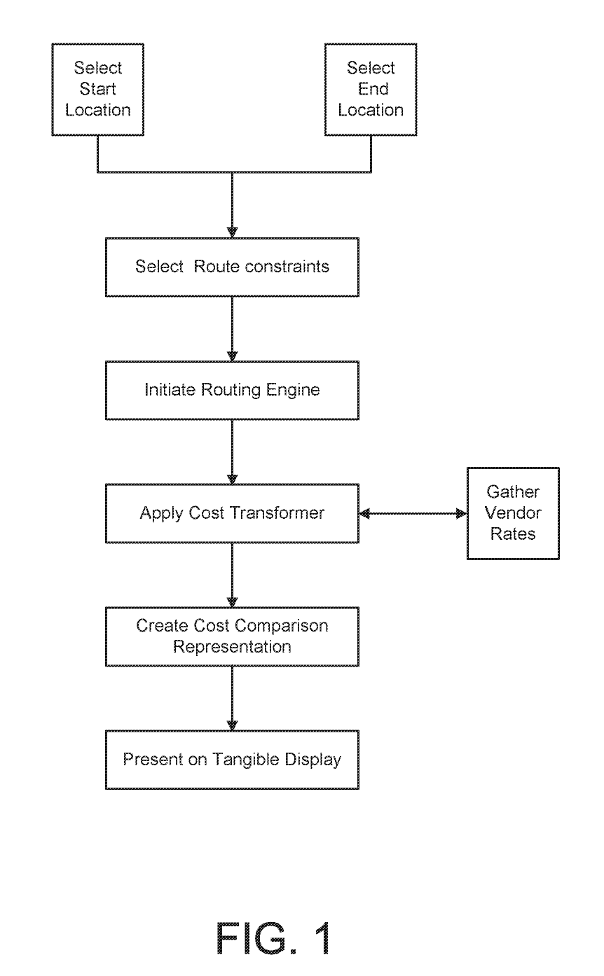

FIG. 2 illustrates a non-limiting example of a route from Start Location 201 to End Location 202. A mass moves from Origin Segment 203 to Waypoint 204 and to Destination Segment 205 by Vessel 206.

### DETAILED DESCRIPTION

Better transportation systems and methods have now been invented. Disclosed herein are new systems and methods for moving mass from a start location to an end location, which provide shippers with reduced costs, improved logistics flexibility, a visualized supply chain, and powerful analytics.

The systems and methods disclosed herein allow a shipper to request and book shipments for moving one or more things from a start location to an end location, track the movement of those things in real-time, visualize the supply chain relevant to those things, and access analytics summarizing the movement of those things.

The systems and methods disclosed herein allow a shipper to customize and integrate global transportation solutions, move things between two points almost anywhere in the world with greater efficiency, while leveraging both space allocation and pricing.

The systems and methods disclosed herein allow a shipper to manage global freight shipments through an online dashboard, which presents information about shipments, price quotes, products, logistics network, analytics, and billing in one easily accessible representation. In one embodiment, the online dashboard comprises a graphical user interface.

As used herein, the term “shipper” refers to an entity moving mass from one location to another. In one embodiment, the shipper moves mass through practicing the methods and systems disclosed herein. In one embodiment, the shipper is a freight forwarder. In one embodiment, the shipper is a user, e.g., an entity practicing the methods or using the systems as disclosed herein.

Within the context of this application, the term “user” includes a person interacting with software, for example a service provider managing a client's inventory. A user has access to a client's information allowing the user to assist in efficiently managing a supply chain for keeping products in the stream of commerce. The term “user” can also refer to an entity managing freight services for assisting in the movement of mass. The user practices the systems and methods disclosed herein for managing freight services on behalf of others, e.g., business entities.

Owing to the systems and methods disclosed herein, freight forwarders no longer need to guess at the best routes for moving things. Nor do freight forwarders need to manually compile and evaluate the intractable quantities of data that would be required to identify and evaluate the best options for moving one or more things between two points.

Disclosed herein is a system for moving mass from one location to another location, comprising:

a Start Location;

an End Location;

a Route Constraint;

a Routing Engine;

a Cost Transformer; and

a Cost Comparison Representation;

wherein the Start Location is defined by a system user through an input means;
wherein the End Location is defined by a system user through an input means;
wherein the Route Constraint is chosen from transportation mode, vendor, rate, partner, or cargo type;
wherein the Routing Engine generates a Segment Chain, capable of moving the mass from the Start Location to the End Location, the Segment Chain comprising a Freight Segment, an Origin Segment, and a Destination Segment;
wherein the Cost Transformer provides the Total Cost for the Segment Chain, the Total Cost comprising Origin Charges, Freight Charges, and Destination Charges;
wherein the Cost Comparison Representation provides a physical representation of the Total Cost for the Segment Chain.

As used herein, the term “moving” means changing the physical location of the thing being moved. For example, “moving” mass mean changing the coordinates of that mass, where those coordinates may be defined by a variety of known methods, such as GPS coordinates, Cartesian coordinates, polar coordinates, etc.

As used herein, the term “mass” means an object made of physical matter. Within the context of this disclosure a “mass” is made of one or more concrete, definite molecules, which occupy volume and can be measured according to weight on the planet Earth. In one embodiment, the mass is a freight. In one embodiment, the mass is cargo.

As used herein, the term “freight” refers to a quantity of mass moving from one location to another, i.e., the cargo. The freight may be any type of matter in any physical form, e.g., textiles, clothing, books, consumer electronics, toys, bikes, food products, etc.

As used herein, the term “location” means a place that can be defined by a variety of known methods, such as GPS coordinates, Cartesian coordinates, polar coordinates, etc.

As used herein, the term “Start Location” means the specific geographic place occupied by a thing when the process of moving that thing begins. For example, when shipping a thing from Shenzhen to Bakersfield, the “Start Location” would be Shenzhen (the place from which the thing is shipped).

Within the context of this disclosure, the term “Start Location” may also be referred to as an Origin, Departure Location, etc.

As used herein, the term “End Location” means the specific geographic place occupied by a thing when the process of moving that thing concludes. For example, when shipping a thing from Shenzhen to Bakersfield, the “End Location” would be Bakersfield (the place to which the thing is shipped).

Within the context of this disclosure, the term “End Location” may also be referred to as a Destination, Arrival Location, etc.

As used herein, the term “Route Constraint” means a criterion that must be satisfied throughout moving the thing between the Start Location and the End Location. For example, the term “Route Constraint” may include a transportation mode requirement, in which case the movement of the thing between the Start Location and the End Location must adhere to a particular transportation mode. In one example, moving the thing between the Start Location and the End Location must include moving the thing via ocean freight. In another example, the “Route Constraint” may include excluding a particular transportation mode. For example, a “Route Constraint” may include avoiding transporting a particular thing by air transport. In one embodiment, a rate validity filter verifies the “Route Constraint”, e.g., verifying the date of delivery.

As used herein, the term “Routing Engine” means path generation tool, which provides a comprehensive set of paths through which the mass can travel to move the maser from the Start Location to the End Location. In one example, the Routing Engine takes in the shipment Start and End location, the Route Constraint(s), and performs an exhaustive search of all possible chains of segments between the Start Location and the End Location, wherein each chain of segment connects the Start Location to the End Location. In one example, the Routing Engine parses the chain of segments connecting the Start Location to the End Location into individual segments. In one example, the Routing Engine generates a collection of segment chains, each of segment chain comprising an origin segment, a destination segment, and a freight segment. In one embodiment, the Routing Engine searches for nearby facilitators, e.g., ports, airports, partners, etc. In one embodiment, the Routing Engine searches for a Start Location and/or an End Location, e.g., ports, cities, etc. In one embodiment, the Routing Engine searches by service type, e.g., less than container load, full container load, etc. In one embodiment, the Routing Engine searches for a carrier and/or partner. In one embodiment, the Routing Engine searches for segment chains by time of arrival and/or departure. In one embodiment, the Routing Engine searches for waypoints. In one embodiment, the Routing Engine searches for previous segment chains. In one embodiment, the Routing Engine searches and verifies, e.g., a date of delivery, a valid partner, etc. In one embodiment, the Routing Engine displays information on a graphical user interface (GUI).

As used herein, the term “graphical user interface” (GUI) refers to a visual medium on a tangible display allowing a user to manipulate icons, windows, symbols, menus, etc. In one embodiment, the display comprises a computer screen. In one embodiment, the display comprises a mobile device, such as a cell phone.

Within, the context of this disclosure the display also includes channels. Examples of channels include, but are not limited to, web/mobile, Internet, email, etc.

Within the context of this disclosure, “graphical user interface” also refers to the configuration and layout of information presented on a display.

As used herein, the term “waypoint” refers to a geographical point along a route. In one embodiment, the waypoint is a port. In one embodiment, the waypoint is a stop along a route. In one example, the Start Location is Los Angeles, Calif. and the End Location is Beijing, China and the waypoint is a port. In one example, the Start Location is San Francisco, Calif. and the End Location is Tokyo, Japan and the waypoint is Vancouver, Canada.

As used herein, the term “Freight Segment” means a portion of the route between the Start Location and the End Location. In one embodiment the term “Freight Segment” means the most substantial portion of the route between the Start Location and the End Location. In one embodiment, the phrase “most substantial” means the portion requiring the greatest displacement of the mass being moved. In another embodiment, the term “most substantial” means the portion requiring the greatest cost, for example dollar cost or other monetary equivalent.

As used herein, the term “Origin Segment” means a portion of the route beginning at the Start Location and along the route to the End Location.

As used herein, the term “Destination Segment” means a portion of the route ending at the End Location and beginning at another position along the route.

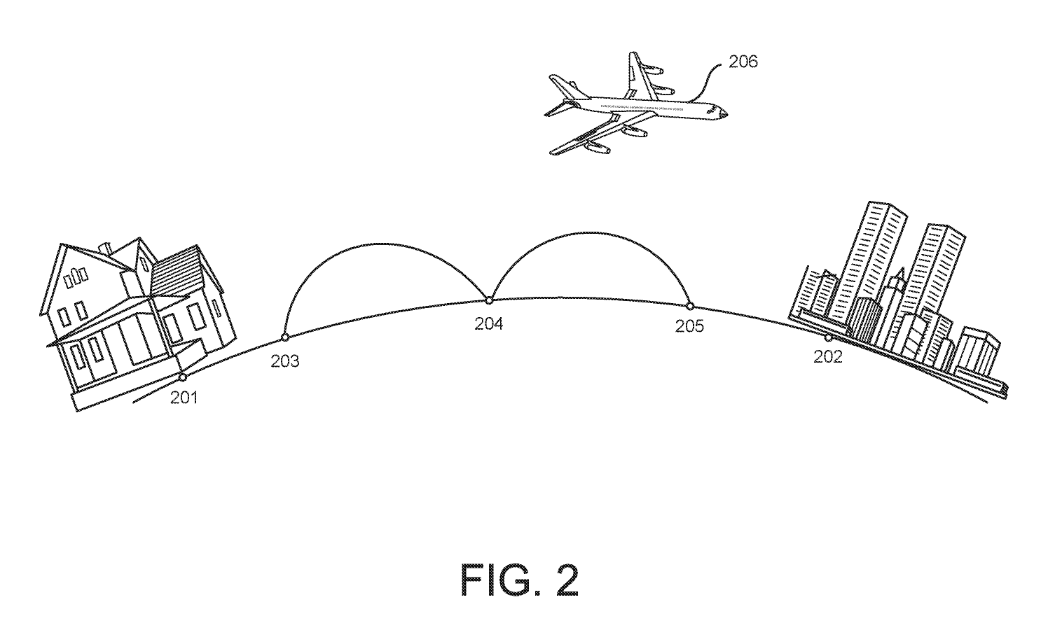

FIG. 2 illustrates a non-limiting example of a route, from Start Location 201 to End Location 202, in which a mass moves from Origin Segment 203 to Waypoint 204 and Destination Segment 205 by Vessel 206.

As used herein, the term “Cost Transformer” means a calculator, which specifically sums the cost of the segments, which make up a route generated by the routing engine. In one embodiment, the Cost Transformer is represented on a GUI. In one example, the Cost Transformer sums Freight Charges, Origin Charges, and Destination Charges. In another example, the Cost Transformer sums Freight Charges, Origin Charges, Destination Charges, and Customs Charges. In another example, the Cost Transformer sums Freight Charges, Origin Charges, Destination Charges, Customs Charges, and other additional charges.

In one example, the Cost Transformer generates Origin Charges by summing charges comprising automated manifest system charges. In one example, the Cost Transformer generates Origin Charges by summing charges comprising export customs clearance charges. In one example, the Cost Transformer generates Origin Charges by summing charges comprising document charges.

In one example, the Cost Transformer generates Origin Charges by summing charges comprising equipment charges. In one example, the Cost Transformer generates Origin Charges by summing charges comprising handling charges. In one example, the Cost Transformer generates Origin Charges by summing charges comprising pickup charges. In one example, the Cost Transformer generates Origin Charges by summing charges comprising seal fee charges. In one example, the Cost Transformer generates Origin Charges by summing charges comprising terminal charges.

In one example, the Cost Transformer generates Destination Charges by summing charges comprising chassis charges. In one example, the Cost Transformer generates Destination Charges by summing charges comprising document charges. In one example, the Cost Transformer generates Destination Charges by summing charges comprising pickup and delivery charges. In one example, the Cost Transformer generates Destination Charges by summing charges comprising pier pass charges.

In one example, the Cost Transformer generates additional charges by summing charges comprising insurance charges. In one embodiment, the insurance charges are calculated based on an insured amount comprising the total invoice value+total freight value.

As used herein, the term “Cost Comparison Representation” means a tangible display, presenting charges associated with moving mass from the Start Location to the End Location pursuant to the Route Constraints. In one example, the Total Cost for each segment chain is organized by freight provider. In one example, the Cost Comparison Representation includes a representation of a Freight Segment. In one example, the Cost Comparison Representation includes a representation of an Origin Segment. In one example, the Cost Comparison Representation includes a representation of a Destination Segment. In one example, the Cost Comparison Representation includes a representation of a Freight Segment, an Origin Segment, and a Destination Segment. In one example, the Cost Comparison Representation includes a representation of a Freight Segment, an Origin Segment, a Destination Segment, and customs clearance charges. In one example, the Cost Comparison Representation includes a representation of a Freight Segment, an Origin Segment, a Destination Segment, and additional charges. In one example, the Cost Comparison Representation includes a representation of a Freight Segment, an Origin Segment, a Destination Segment, customs clearance charges, and additional charges. In one example, the Cost Comparison Representation displays a representation of a Freight Segment, an Origin Segment, and a Destination Segment by juxtaposing freight providers. In one example, the Cost Comparison Representation displays a representation of a Freight Segment, an Origin Segment, a Destination Segment by juxtaposing freight providers and providing the total cost associated with moving mass via a route from the Start Location to the End Location and including a Freight Segment fulfilled by the freight provider.

As used herein, the term “input means” refers to something capable of accepting information from a shipper, such as a keyboard, mouse, voice recognition tool, or any other method or device capable of accepting a statement from a human being. In one example, the input means is a computer terminal, such as a desktop, laptop, or handheld device computer.

As used herein, the term “transportation mode” means a method used to physically move mass, such as a ship, airplane, automobile, etc. In one example, the “transportation mode” is chosen from ocean and air. In one embodiment, the transportation mode comprises a combination of methods, e.g., rail and ship.

As used herein, the term “vendor” means a seller. In one example, a vendor sells shipping services.

As used herein, the term “rate” means the amount charged per unit sold.

As used herein, the term “partner” means an entity participating in the movement of mass from the Start Location to the End Location, such as an entity specifically designed for providing transportation services. In one embodiment, the partner is a freight service partner or freight provider.

As used herein, the term “freight service partner” refers to an entity facilitating movement of mass from one location to another. In some embodiments, one freight service partner is used for moving mass. In some embodiments, multiple freight service partners are used for moving mass. In some embodiments, a freight service partner may not offer all the services required for moving mass across the entire route of a cargo. In some embodiments, some freight service partners may only offer shipment by plane. In some embodiments, some freight service partners may only offer shipment by train. In some embodiments, some freight service partners may only offer shipment by truck. In some embodiments, some freight service partners may only offer shipment by ship. To that end, multiple freight service partners are required to facilitate the movement of mass. In some embodiments, some freight service partners may offer a variety of services to one location. In some embodiments, some freight service partners may offer a variety of prices for shipment to the same location but different arrival dates. In some embodiments, different freight service partners may offer different services to the same location for different prices.

As used herein, the term “cargo type” means the size of the mass moved from the Start Location to the End Location. In one example, the cargo type refers to the size requirements for a particular shipment, for example a 20′ container, 40′ container, 40′ high-cube container, 45′ high-cube container, or less-than container.

As used herein, the term “Segment Chain” means a sequence of movements of a particular mass, connecting the Start Location and the End Location. In one example the Segment Chain comprises an origin segment, a destination segment, and a freight segment.

As used herein, the term “Total Cost” means the summation of monetary costs for moving the mass from the Start Location to the End Location through a particular route.

As used herein, the term “physical representation” means a tangible display comprising mass and energy in some definite observable form—as opposed to an abstract idea. Disclosed herein is a method for moving mass from one location to another location, comprising:

selecting a Start Location, wherein the Start Location is defined by a system user through an input means;

selecting an End Location, wherein the End Location is defined by a system user through an input means;

fulfilling a Route Constraint; wherein the Route Constraint is chosen from transportation mode, vendor, rate, partner, or cargo type;

utilizing a Routing Engine; wherein the Routing Engine generates at least two Segment Chains, each capable of moving the mass from the Start Location to the End Location, each Segment Chain comprising a Freight Segment, an Origin Segment, and a Destination Segment;

calculating with a Cost Transformer, wherein the Cost Transformer provides the Total Cost for each Segment Chain, the Total Cost comprising Origin Charges, Freight Charges, and Destination Charges; and

presenting a Cost Comparison Representation, wherein the Cost Comparison Representation provides a physical representation of the Total Cost for each of the Segment Chains.

As used herein, the term “selecting” refers to choosing, picking, and/or electing. In one embodiment, selecting comprises choosing a geographic location from which mass is moved from or to. In one embodiment, selecting comprises utilizing a graphical user interface. In one embodiment, selecting comprises choosing Chicago as a Start Location. In one embodiment, selecting comprises choosing Shanghai as an End Location.

As used herein, the term “fulfilling” refers to completing, accomplishing, satisfying, finishing, executing, abiding, and/or achieving. In one embodiment, fulfilling comprises completing a route. In one embodiment, fulfilling comprises completing a Freight Segment. In one embodiment, fulfilling comprises abiding a Route Constraint. In one embodiment, fulfilling comprises using a ship for transporting mass. In one embodiment, fulfilling comprises arriving at a certain time and/or date. In one embodiment, fulfilling comprises arriving at the End Location.

As used herein, the term “utilizing” refers to using, applying, employing, and/or operating. In one embodiment, utilizing comprises a shipper using the methods and systems disclosed herein for moving mass. In one embodiment, utilizing comprises using a Routing Engine to generate a route for moving mass from a Start Location to an End Location. In one embodiment, utilizing comprises a shipper operating the Routing Engine to move mass from Shanghai to Chicago.

As used herein, the term “calculating” refers to computing a value or values based on a set of information. In one embodiment, calculating comprises determining the cost of moving mass. In one embodiment, calculating comprises evaluating a Total Cost with a Cost Transformer. In one embodiment, calculating comprises determining the cost to move mass from Yantian to Norfolk. In a further embodiment, calculating comprises determining the cost of moving mass from Yantian to Norfolk based on shipping size, e.g., less than container load, full container load, etc. In one embodiment, calculating comprises the transportation method, e.g., plane, ship, rail, etc.

As used herein, the term “presenting” refers to visualizing, showing, illustrating, displaying, and/or demonstrating. In one embodiment, presenting comprises showing the Cost Comparison Representation. In one embodiment, presenting comprises showing the Cost Comparison Representation on a screen, display, monitor, etc. In one embodiment, presenting comprises showing the Cost Comparison Representation on a mobile device. In one embodiment, presenting comprises showing the Cost Comparison Representation on a computer.

In one example, the Total Cost is organized by freight provider.

In one example of the disclosed method for moving mass, the Cost Comparison Representation comprises separating the two segment chains according to the Freight Segment.

In one example of the disclosed method for moving mass, the Route Constraint is transportation mode.

In one example of the disclosed method for moving mass, the transportation mode is chosen from air or ocean.

In one example of the disclosed method for moving mass, the Total Cost comprises Origin Charges, Freight Charges, Destination Charges, and Customs Charges.

In one example of the disclosed method for moving mass, the Cost Comparison Representation provides the beginning date for moving the mass and the ending date for moving the mass.

In one example of the disclosed method for moving mass, the Cost Comparison Representation provides the cost per kilogram for moving the mass.

Although the present invention herein has been described with reference to various exemplary embodiments, it is to be understood that these embodiments are merely illustrative of the principles and applications of the present invention. Those having skill in the art would recognize that various modifications to the exemplary embodiments might be made, without departing from the scope of the invention.

Moreover, it should be understood that various features and/or characteristics of differing embodiments herein might be combined with one another. It is therefore to be understood that numerous modifications may be made to the illustrative embodiments and that other arrangements may be devised without departing from the scope of the invention.

Furthermore, other embodiments of the invention will be apparent to those skilled in the art from consideration of the specification and practice of the invention disclosed herein. It is intended that the specification and examples be considered as exemplary only, with a scope and spirit being indicated by the claims.

Finally, it is noted that, as used in this specification and the appended claims, the singular forms “a,” “an,” and “the,” include plural referents unless expressly and unequivocally limited to one referent, and vice versa. As used herein, the term “include” or “comprising” and its grammatical variants are intended to be non-limiting, such that recitation of an item or items is not to the exclusion of other like items that can be substituted or added to the recited item(s).

1. A system for moving mass from one location to another location, comprising:
a Start Location;
an End Location;
a Route Constraint;
a Routing Engine;
a Cost Transformer; and
a Cost Comparison Representation;
wherein the Start Location is defined by a system user through an input means;
wherein the End Location is defined by a system user through an input means;
wherein the Route Constraint is chosen from transportation mode, vendor, rate, partner, or cargo type;
wherein the Routing Engine generates a Segment Chain, capable of moving the mass from the Start Location to the End Location, the Segment Chain comprising a Freight Segment, an Origin Segment, and a Destination Segment;
wherein the Cost Transformer provides the Total Cost for the Segment Chain, the Total Cost comprising Origin Charges, Freight Charges, and Destination Charges; and
wherein the Cost Comparison Representation provides a physical representation of the Total Cost for the Segment Chain.

2. The system of claim 1, comprising two segment chains.

3. The system of claim 2, wherein the Cost Comparison Representation separates the two segment chains according to the freight Segment.

4. The system of claim 1, wherein the Route Constraint is transportation mode.

5. The system of claim 4, wherein the transportation mode is chosen from air or ocean.

6. The system of claim 1, wherein the Total Cost comprises Origin Charges, Freight Charges, Destination Charges, and Customs Charges.

7. (canceled)

8. The system of claim 3, wherein the Cost Comparison Representation provides the beginning date for moving the mass and the ending date for moving the mass.

9. The system of claim 3, wherein the Cost Comparison Representation provides the cost per kilogram for moving the mass.

10. A method for moving mass from one location to another location, comprising:
selecting a Start Location, wherein the Start Location is defined by a system user through an input means;
selecting an End Location, wherein the End Location is defined by a system user through an input means;
fulfilling a Route Constraint; wherein the Route Constraint is chosen from transportation mode, vendor, rate, partner, or cargo type;
utilizing a Routing Engine; wherein the Routing Engine generates at least two Segment Chains, each capable of moving the mass from the Start Location to the End Location, each Segment Chain comprising a Freight Segment, an Origin Segment, and a Destination Segment;
calculating with a Cost Transformer, wherein the Cost Transformer provides the Total Cost for each Segment Chain, the Total Cost comprising Origin Charges, Freight Charges, and Destination Charges; and
presenting a Cost Comparison Representation, wherein the Cost Comparison Representation provides a physical representation of the Total Cost for each of the Segment Chains.

11. The method of claim 10, comprising two segment chains.

12. The method of claim 10, wherein the Total Cost is organized by freight provider.

13. The method of claim 10, comprising separating the two segment chains according to the Freight Segment.

14. The method of claim 10, the Route Constraint is transportation mode.

15. The method of claim 14, the transportation mode is chosen from air or ocean.

16. The method of claim 10, wherein the Total Cost comprises Origin Charges, Freight Charges, Destination Charges, and Customs Charges.

17. The method of claim 10, comprising providing a beginning date for moving the mass and an ending date for moving the mass.

18. The method of claim 10, providing a cost per kilogram for moving the mass.
